(19) United States
(12) Patent Application Publication
(10) Pub. No.: US 2014/0125071 A1
(43) Pub. Date: May 8, 2014

(54) VEHICLE DOOR HANDLE ASSEMBLY WITH CONCEALED KEY CYLINDER

(71) Applicant: Mark McWilliams, Wyoming, MI (US)

(72) Inventor: Mark McWilliams, Wyoming, MI (US)

(21) Appl. No.: 13/981,531

(22) PCT Filed: Feb. 1, 2012
(86) PCT No.: PCT/US12/23501

§ 371 Date: Jan. 16, 2014

Related U.S. Application Data
(60) Provisional application No. 61/438,456, filed on Feb. 1, 2011.

(51) Int. Cl. E05B 65/10

(52) U.S. Cl. CPC E05B 65/10
USPC 292/336.3

(57) ABSTRACT

A handle assembly for a vehicle door, the handle assembly comprising a fixed base portion attachable to a vehicle door, the fixed base portion having disposed therein a key cylinder forming part of a latch assembly for the vehicle door, at least the keyway of which key cylinder is exposed through an opening in the fixed base portion. A movable grab-handle portion is attachable to the vehicle door and movable relative to the fixed base portion. A push-push latch mechanism is disposed in the fixed base portion. A cover is pivotally connected to the fixed base portion. The cover is manually pivotally movable between a first, opened position in which the key cylinder is exposed and a second, closed position, in which the key cylinder is concealed beneath the cover. The cover is engageable with the push-push latch mechanism in the second, closed position thereof to secure the cover in the second, closed position.

### CROSS-REFERENCE TO RELATED APPLICATIONS

The present application is related to, and claims the benefit of priority from, U.S. Provisional Patent Application Ser. No. 61/438,456, filed 1 Feb. 2011, the disclosure of which is incorporated herein by reference in its entirety.

### FIELD OF THE INVENTION

The present invention pertains to a handle for a vehicle door, the handle assembly comprising a fixed base portion having disposed therein a key cylinder at least the keyway of which is exposed through an opening in the fixed base portion. A cover is pivotally connected to the fixed base portion is manually pivotally movable between a first, opened position in which the key cylinder is exposed and a second, closed position, in which the key cylinder is concealed beneath the cover.

### BACKGROUND

Automobile door locks are commonly operated by keyless entry devices allowing an operator to press a button on a key fob to unlock the vehicle doors. Despite the advent of keyless devices, key-actuated latch mechanisms continue to be employed as a secondary device for vehicle entry when the key fob is lost or no power is supplied to the vehicle's electronics (due, for instance, to a drained vehicle battery). The keyways of these key-actuated latch mechanisms are typically exposed for easy access by a user. This permits the key cylinder to be exposed to the elements, and so creates the potential for the keyway to become at least temporarily inaccessible due to ice, debris, etc. Additionally, the overall appearance of the vehicle door is of concern as the visibility of the keyway of a key cylinder may disrupt the aesthetic appearance of the vehicle.

In one solution to the foregoing problem, Haltenberger, U.S. Pat. No. 2,670,623, discloses a cover assembly that is quickly mountable and demountable through the usage of a hand removable rubber thimble to be used when weather conditions require additional protection for the lock cylinder. Snively, U.S. Pat. No. 2,096,568, discloses a lock cylinder cover adapted for use on door mounted locks which possesses a frame mounting to the automobile door. A cap is mounted at the top of the frame, the cap being held either opened or closed through the use of a spring. Finally, Smith, U.S. Pat. No. 4,773,242, discloses a rotational deck-lid lock cylinder protection device which consists of a lock cylinder with a pivotally-mounted cover plate that rotates between an open and closed position based upon positioning of detents.

Yet despite the foregoing, a satisfactory solution to the problem of concealing the key cylinder has yet to be devised.

### SUMMARY

The present invention comprehends a handle assembly for a vehicle door, the handle assembly comprising a fixed base portion attachable to a vehicle door, the fixed base portion having disposed therein a key cylinder forming part of a latch assembly for the vehicle door, at least the keyway of which key cylinder is exposed through an opening in the fixed base portion. A movable grab-handle portion is attachable to the vehicle door and movable relative to the fixed base portion. A push-push latch mechanism is disposed in the fixed base portion. A cover is pivotally connected to the fixed base portion, the cover manually pivotally movable between a first, opened position in which the key cylinder is exposed and a second, closed position, in which the key cylinder is concealed beneath the cover. The cover is engageable with the push-push latch mechanism in the second, closed position thereof to secure the cover in the second, closed position.

According to one feature, the cover is engageable with the push-push latch mechanism via a tab projecting inwardly from an inside surface of the cover. In one embodiment, the tab may comprises a male end with radially extending prongs receivable between correspondingly shaped prongs of the push-push latch mechanism.

Per another feature, the cover comprises a generally U-shaped arm having trunnions extending oppositely therefrom. The trunnions are movably mounted within the fixed base portion to pivotally connect the cover to the fixed base portion. In one embodiment, the cover, U-shaped arm and trunnions may be monolithic.

According to still another feature of the present invention, in the second, closed position of the cover, an exterior surface of the cover is disposed substantially flush with a top of the fixed base portion. In one exemplary embodiment, the fixed base portion includes a recessed opening the depth and overall shape of which corresponds approximately to the thickness and overall shape of the cover.

Per a further feature, the cover is sealed with respect to the fixed base portion in the second, closed position of the cover. In one embodiment, sealing is accomplished by a compressible gasket provided between and attached to either of the fixed base portion or the cover, the gasket at least substantially surrounding the keyway.

Per yet another feature, the grab handle includes separate trim and inset portions, the inset portion complimentary in shape and appearance to the shape and appearance of cover, and the trim portion complimentary in shape and appearance to the shape and appearance of the fixed base portion surrounding the cover.

### BRIEF DESCRIPTION OF THE DRAWINGS

For a better understanding of the invention, and to show more clearly how it may be carried into effect according to one or more embodiments thereof, reference will now be made, by way of example, to the accompanying drawings, showing exemplary embodiments of the present invention and in which:

FIG. 1 depicts the door handle assembly including the grab handle portion and the fixed portion holding the concealed lock cylinder;

FIG. 2 depicts the fixed portion of the door handle with the cover in the first, opened position;

FIG. 3 depicts the fixed portion of the door handle with the cover in the second, closed position;

FIG. 4 is another depiction of the fixed portion of the door handle with the cover in the first, opened position;

FIG. 5 is a simplified cross-sectional view of the fixed portion of the door handle, demonstrating both the first, opened and the second, closed positions of the cover; and

FIG. 6 is a simplified cross-sectional view of the fixed portion of the door handle, showing the cover in the second, closed position.

### WRITTEN DESCRIPTION

As required, detailed embodiments of the present invention are disclosed herein. However, it is to be understood that the disclosed embodiments are merely exemplary of the invention that may be embodied in various and alternative forms. Therefore, specific structural and functional details disclosed herein are not to be interpreted as limiting, but merely as a representative basis for teaching one skilled in the art to variously employ the present invention.

The accompanying drawings are not necessarily to scale, and some features may be exaggerated or minimized to show details of particular components.

Referring now to the drawings, wherein like numerals refer to like or corresponding parts throughout the several views, the present invention is generally characterized as a handle assembly (indicated generally at 1) for a vehicle door D, the handle assembly comprising a fixed base portion (indicated generally at 2) attachable to the vehicle door and a movable grab-handle 15 portion attachable to the vehicle door and movable relative to the fixed base portion 2. Except as discussed in respect of the concealment of the key cylinder, the handle assembly is of conventional construction and operation. The fixed base portion 2 has disposed therein a key cylinder 3 forming part of a conventional latch assembly for the vehicle door, at least the keyway 4 of which key cylinder 3 is exposed through an opening 5 defined in the housing of the fixed base portion 2 so as to be accessible to a user seeking to unlatch the vehicle door with a key, rather than via remote entry means.

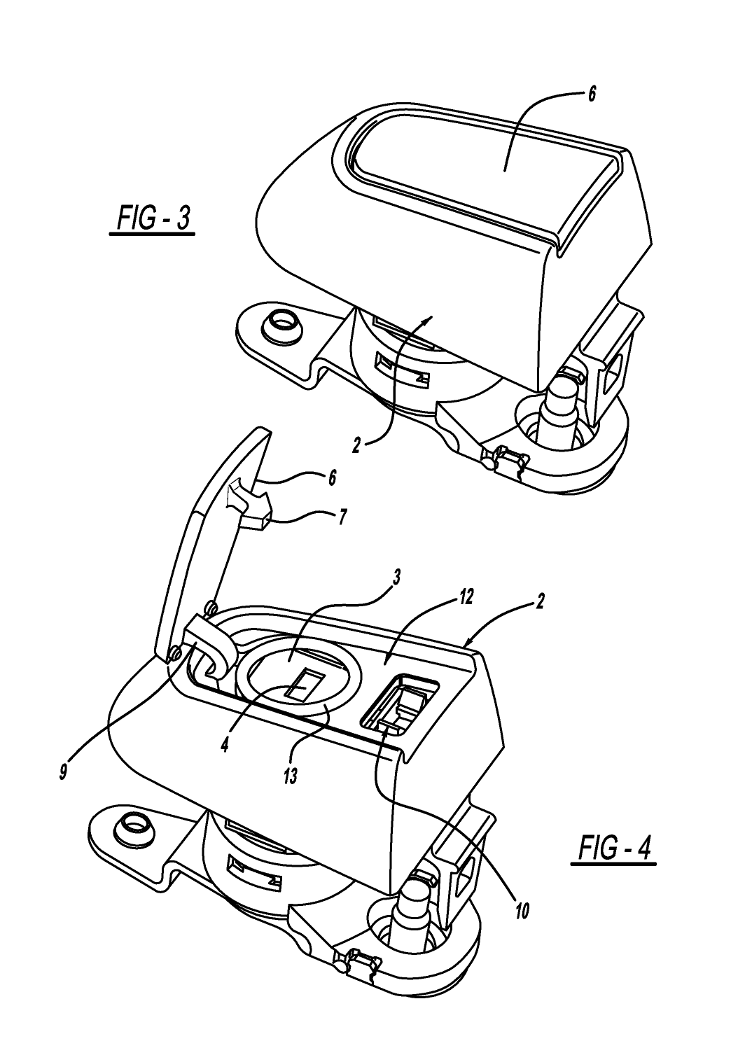

To permit selective concealment and exposure of the keyway 4, a cover 6 is pivotally connected to the fixed base portion 2, the cover 6 being manually pivotally movable between a first, opened position (shown in FIG. 4) in which the keyway 4 of key cylinder 3 is exposed and a second, closed position (shown in FIG. 3), in which the key cylinder 3 (including keyway 4) is concealed beneath the cover 6.

Cover 6 may be made of any suitable material, including, by way of non-limiting example, metal or plastic, or a combination thereof.

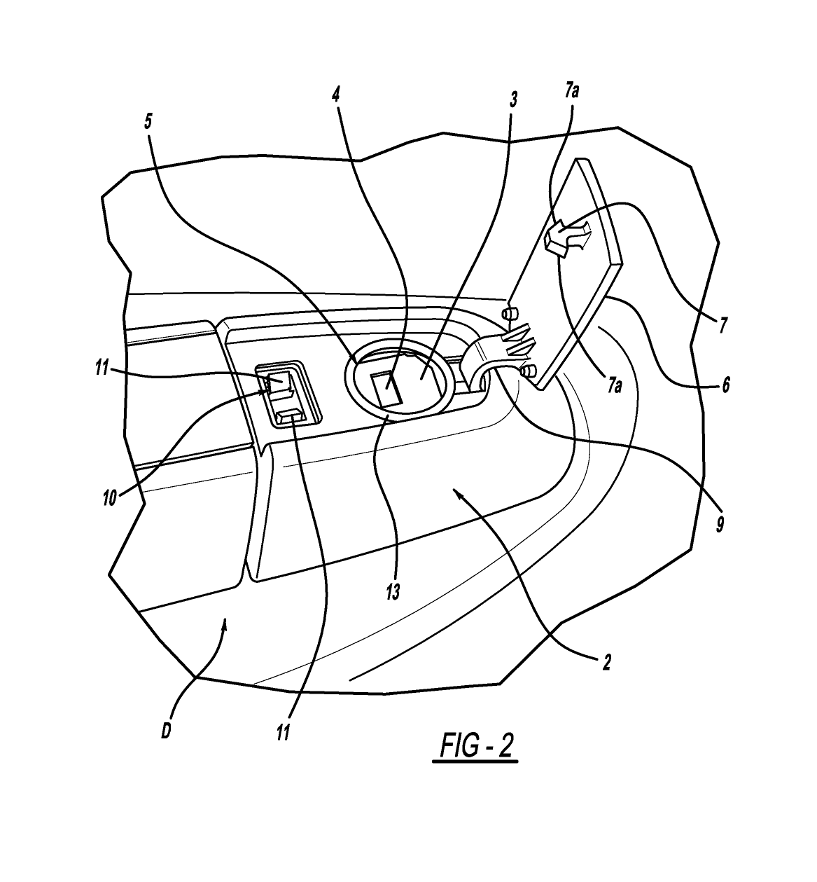

A push-push latch mechanism (indicated generally at 10) is disposed in the fixed base portion 2, the cover 6 being engageable in the second, closed position thereof with the push-push latch mechanism 10 via a tab 7 projecting inwardly from the inside surface of cover 6. Tab 7 includes, as shown in FIG. 2, a male end with radially extending prongs 7a receivable between correspondingly shaped prongs 11 of the latch mechanism 10 so as to secure the cover 6 in the second, closed position. Per convention, the prongs 11 of latch mechanism 10 release the male end of tab 7 when the cover 6 is pushed slightly inwardly when in the second, closed position thereof, thereby permitting a user to manually pivot the cover 6 into the first, opened position thereof.

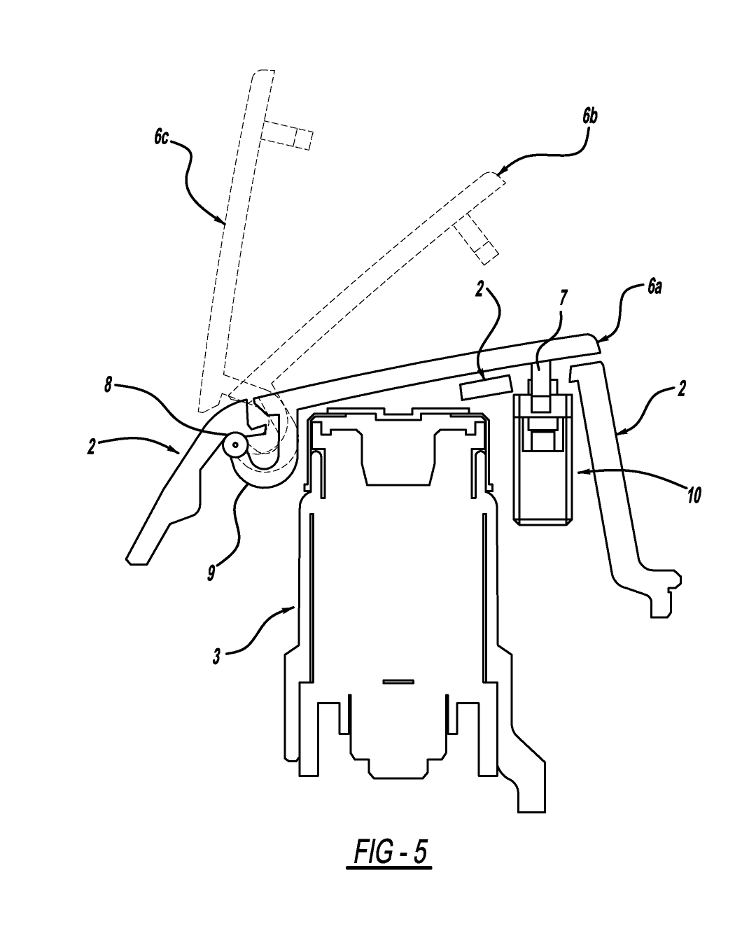

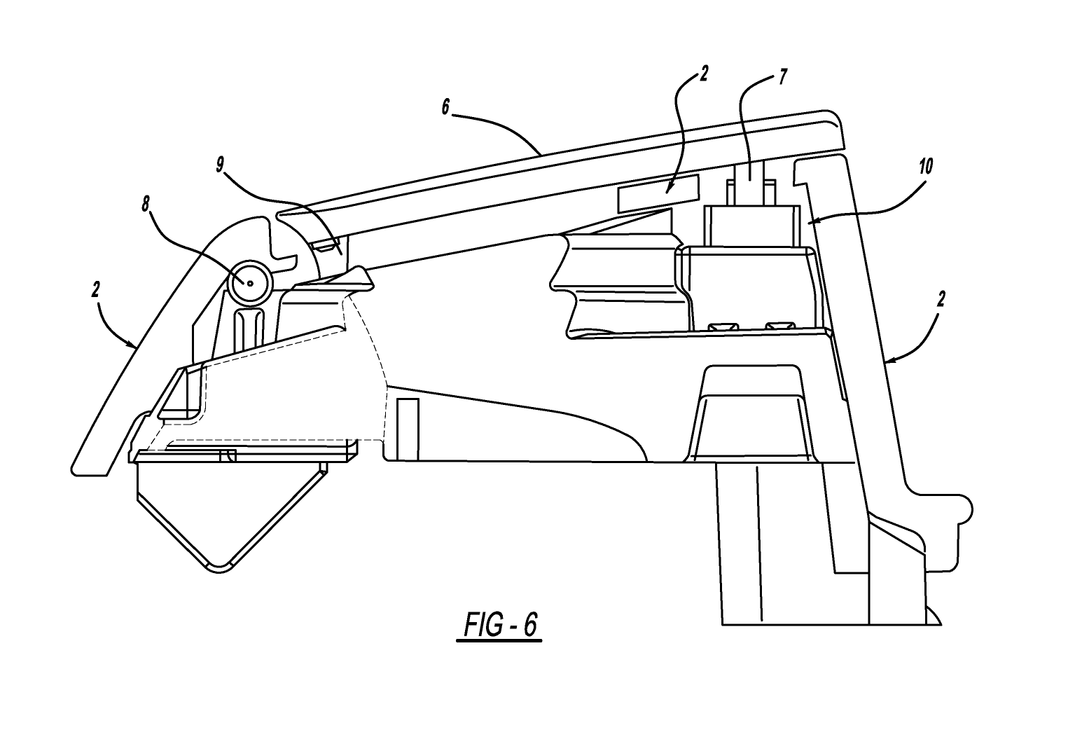

According to the exemplary embodiment, pivotal connection of cover 6 to fixed base portion 2 is accomplished by means of trunnions 8 extending oppositely from a generally U-shaped arm 9 the opposite end of which is connected to the cover 6. Trunnions 8 are movably mounted within the fixed base portion 2 to permit pivotal movement of the cover 6, being, for instance, captured beneath the housing of base portion 2 as best shown in FIGS. 5 and 6. In the illustrated embodiment, cover 6, arm 9 and trunnions 8 are integral, being molded as a single piece. However, these various elements may be separately formed and subsequently integrated into a unitary whole by any conventional means.

The foregoing is not intended to be limiting of the present invention, however, and it will be appreciated that other, conventional means may be employed to pivotally secure cover 6 to the fixed base portion 2.

As best shown in FIGS. 2 through 4, the present invention according to the illustrated embodiment is characterized by the fact that the exterior surface of the cover 6 is, in the second, closed position thereof disposed substantially flush with the top of the fixed base portion 2. To this end, it will be seen that the top part of the housing of fixed base portion 2 defines a recessed opening 12 the depth and overall shape of which corresponds approximately to the thickness and overall shape of the cover 6.

Optionally, the cover 6 may be sealed with respect to the base portion 2 in the second, closed position of the cover 6 in order to better prevent debris, ice, etc. from obstructing or damaging the keyway 4. Such sealing may, by way of example, be accomplished by the provision of a compressible gasket 13 between and attached to either of the base portion 2 or cover 6, the gasket at least substantially surrounding the keyway 4. In the illustrated embodiment, the gasket 13 is depicted as being disposed about the opening 5.

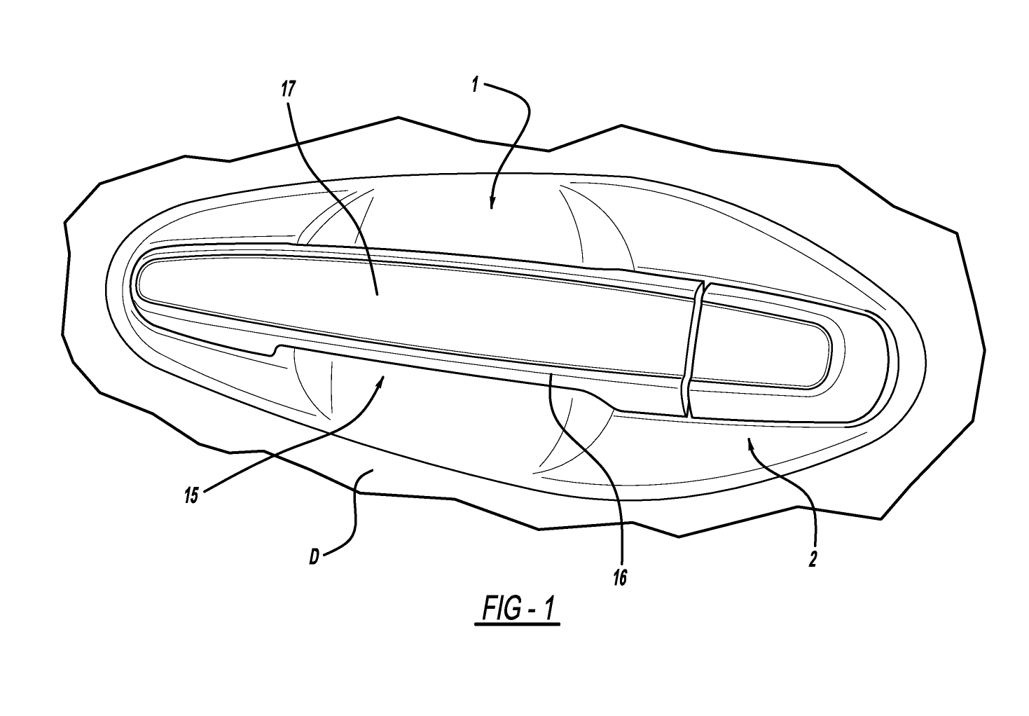

Referring also to FIG. 1, it will be seen that, per the exemplary embodiment of the invention, it may be desirable for aesthetic reasons to provide the grab handle 15 with separate trim 16 and inset 17 portions, the inset portion 17 complimentary in shape and appearance (if distinct) to the shape and appearance of cover 6 and the trim portion 16 complimentary in shape and appearance (if distinct) to the housing of the fixed base portion 2 surrounding the cover 6. In this manner, the cover 6 may be further blended into, and so further concealed with respect to, the overall appearance of the handle assembly 1.

In operation, the user pushes the cover 6 slightly inwardly toward the base portion 2 in the second, closed position (6a in FIG. 5) of cover 6. This action effects release of the male end of tab 7 by the prongs 11 of latch mechanism 10 and, simultaneously, urges cover 6 slightly outwardly away from base portion 2. From this position, the user can position one or more fingers beneath the cover 6 (i.e., between the cover 6 and fixed base portion 2) to manually pivot cover 6 about the pivot point defined by trunnions 8, through intermediate position (6b in FIG. 5) and to the first, opened position of cover 6 (6c in FIG. 5). With the cover in this opened position, the user may access the keyway of key cylinder 3 to manually unlatch the vehicle door. To close the door 6, the user simply performs the reverse of the foregoing operation until the male end of tab 7 is received between prongs 11 of the latch mechanism 10 and the cover 6 is secured in the second, closed position thereof.

The foregoing description of the exemplary embodiment of the invention has been presented for the purpose of illustration and description. It is not intended to be exhaustive of, or to limit, the invention to the precise form disclosed. Modifications and variations are possible in light of the above teachings or as acquired from practice of the invention. The embodiment shown and described in order to explain the principles of the invention and its practical application, which allows one skilled in the art to utilize the invention in its various embodiments and with various modifications, are suited to the particular application contemplated. Accordingly, all such modifications and embodiments are intended to be included within the scope of the invention. Other substitutions, modifications, changes and omissions may be made in the design, operating conditions and arrangements of the exemplary embodiments without departing from the spirit of the present invention.

The invention in which an exclusive property or privilege is claimed is defined as follows:

1. A handle assembly for a vehicle door, the handle assembly comprising:
a fixed base portion attachable to a vehicle door, the fixed base portion having disposed therein a key cylinder forming part of a latch assembly for the vehicle door, at least the keyway of which key cylinder is exposed through an opening in the fixed base portion;
a movable grab-handle portion attachable to the vehicle door and movable relative to the fixed base portion;
a push-push latch mechanism disposed in the fixed base portion;
a cover pivotally connected to the fixed base portion, the cover manually pivotally movable between a first, opened position in which the keyway of the key cylinder is exposed and a second, closed position, in which the key cylinder, including the keyway, is concealed beneath the cover; and
the cover engageable with the push-push latch mechanism in the second, closed position thereof to secure the cover in the second, closed position.

2. The handle assembly of claim 1, wherein the cover is engageable with the push-push latch mechanism via a tab projecting inwardly from an inside surface of the cover.

3. The handle assembly of claim 2, wherein the tab comprises a male end with radially extending prongs receivable between correspondingly shaped prongs of the push-push latch mechanism.

4. The handle assembly of claim 1, wherein the cover comprises a generally U-shaped arm having trunnions extending oppositely therefrom, the trunnions being movably mounted within the fixed base portion to pivotally connect the cover to the fixed base portion.

5. The handle assembly of claim 4, wherein the cover, U-shaped arm and trunnions are monolithic.

6. The handle assembly of claim 1, wherein, in the second, closed position of the cover, an exterior surface of the cover is disposed substantially flush with a top of the fixed base portion.

7. The handle assembly of claim 6, wherein the fixed base portion includes a recessed opening the depth and overall shape of which corresponds approximately to the thickness and overall shape of the cover.

8. The handle assembly of claim 1, wherein the cover is sealed with respect to the fixed base portion in the second, closed position of the cover.

9. The handle assembly of claim 8, wherein a compressible gasket is provided between and attached to either of the fixed base portion or the cover, the gasket at least substantially surrounding the keyway.

10. The handle assembly of claim 1, wherein the grab handle includes separate trim and inset portions, the inset portion complimentary in shape and appearance to the shape and appearance of cover, and the trim portion complimentary in shape and appearance to the shape and appearance of the fixed base portion surrounding the cover.
